(19) United States
(12) Patent Application Publication
(10) Pub. No.: US 2008/0224958 A1
(43) Pub. Date: Sep. 18, 2008

(54) PLASMA DISPLAY DEVICE AND DRIVING APPARATUS THEREOF

(75) Inventors: Kazuhiro ITO, Suwon-si (KR); Kyong-Pil JIN, Suwon-si (KR); Bong-Eun YOON, Suwon-si (KR); Tae-Wook KIM, Suwon-si (KR); Myoung-Kyu LEE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/959,846

(22) Filed: Dec. 19, 2007

(30) Foreign Application Priority Data
Mar. 13, 2007 (KR) 10-2007-0024621

(51) Int. Cl. G09G 3/28

(52) U.S. Cl. 345/68

(57) ABSTRACT

In a plasma display device and a driving apparatus thereof, a scan electrode driver for applying a driving voltage to a scan electrode has a diode including a cathode coupled to a sustain voltage supplying power and an anode coupled to a switch for applying a reset rising waveform to the scan electrode. In the scan electrode driver, when a switch for applying a reset rising waveform is turned on, the voltage at the scan electrode is gradually increased by a voltage that is less than the sustain voltage due to the breakdown voltage of the diode. Therefore, the number of power sources is reduced simplifying the circuit configuration and reducing the plasma display device production cost.

### CROSS-REFERENCE TO RELATED APPLICATION

This application claims the benefit of Korean Patent Application No. 2007-24621 filed in the Korean Intellectual Property Office on Mar. 13, 2007, the disclosure of which is incorporated herein by reference.

### BACKGROUND OF THE INVENTION

1. Field of the Invention

An aspect of the present invention relates to a plasma display device and a driving apparatus thereof.

2. Description of the Related Art

A plasma display device is a flat panel display for displaying characters or images by using plasma generated by a gas discharge. A display panel of the plasma display device has several to hundred millions of discharge cells (referred to as cells hereinafter) in a matrix format according to their sizes.

The plasma display device divides a frame into a plurality of subfields each having a grayscale weight and drives the subfields. In this instance, luminance of the cells is determined by a sum of weights of subfields of corresponding light emitting cells from among the subfields. Each subfield has a reset period, an address period, and a sustain period. The reset period is for resetting the discharge cells. The address period is for performing an address operation to select light emitting cells and non light emitting cells from among the discharge cells. The sustain period is for sustaining a discharge of the cells that are set to be light emitting cells in the address period for a period that corresponds to the weight of the corresponding subfield and displaying the images.

In general, the plasma display device applies a gradually increasing voltage waveform (hereinafter, referred to as a reset rising waveform) to the scan electrode in the reset period, and a sustain pulse to the scan electrode in the sustain period. The plasma display device separately configures a power source for a reset rising waveform and a power source for a sustain pulse. The voltage level of the voltage supplied by the power source and required for the reset rising waveform is different from that of the voltage supplied by the power source and required by the sustain pulse. Accordingly, it is necessary to configure an additional element for preventing an overcharge since the power source for supplying a lower voltage can be overcharged by the difference of the two voltage levels.

The above information disclosed in this Background section is only for enhancement of understanding of the background of the invention and therefore it may contain information that does not form the prior art that is already known in this country to a person of ordinary skill in the art and/or in combination with elements of the prior art.

### SUMMARY OF THE INVENTION

An aspect of the present invention provides a plasma a simplified circuit.

An exemplary embodiment of the present invention provides a plasma display device including a plasma display panel and an electrode driver. The plasma display panel (PDP) includes a plurality of electrodes (scan electrodes), and the electrode driver applies a drive voltage to the electrodes. The electrode driver includes a first switch, a first diode, and a second switch. The first switch is coupled between the electrodes and a first power for supplying a sustain voltage applied to the electrodes in a sustain period. The first diode has a cathode coupled to the first power. The second switch has a first terminal coupled to an anode of the first diode and operates to control a voltage at a second terminal to be gradually increased to a first voltage less than the sustain voltage in part of a reset period.

According to an aspect of the present invention, the electrode driver further includes a third switch, a fourth switch, and a fifth switch. The third switch is coupled between the electrodes and a second power for supplying a second voltage less than the sustain voltage. The fourth switch is coupled between the electrodes and a third power for supplying a scan voltage sequentially applied to the electrodes in an address period. The fifth switch is coupled between the second power and the third power and prevents a voltage less than the second voltage from being applied to the second power when the voltage is less than the second voltage applied to the electrodes. The fifth switch has a first terminal coupled to a second terminal of the second switch. In this instance, the electrode driver further includes a second diode and a sixth switch. The second diode has a cathode coupled to the electrodes. The sixth switch has a first terminal coupled to an anode of the second diode and a second terminal coupled to the third power, and operates to control the voltage at the anode of the second diode to be gradually decreased to a third voltage greater than the scan voltage in part of the reset period in which the second switch is turned off.

According to an aspect of the present invention, the electrode driver further includes a capacitor having a first terminal coupled to a fourth power for supplying a fourth voltage greater than the scan voltage, and the capacitor is charged with a fifth voltage corresponding to a voltage difference between the fourth voltage and the scan voltage through a turn on operation of the fourth switch. When the second switch is turned on, the voltage at the electrodes is gradually increased from the fifth voltage to a sixth voltage that is the sum of the fourth voltage and the fifth voltage through a current path including the first power, the first diode, the second switch, the fifth switch, and the capacitor. The first voltage is less than the sustain voltage by a breakdown voltage of the first diode.

Another embodiment of the present invention provides a driver for a plasma display device including a plurality of electrodes (scan electrodes) including a first switch, a second switch, and a first Zener diode. The first switch is coupled between the electrodes and a first power for supplying a sustain voltage applied to the electrodes in a sustain period, and applies the sustain voltage to the electrodes when the first switch is turned on. The second switch has a first terminal coupled to the first power. The first Zener diode has a cathode coupled to a second terminal of the second switch and an anode coupled to the electrodes The second switch controls a voltage at the anode of the first Zener diode, to be gradually increased to a first voltage that is less than the sustain voltage, in part of the reset period.

According to an aspect of the present invention, the driver includes a third switch, a fourth switch, a second Zener diode, and a fifth switch. The third switch is coupled between the electrodes and a second power for supplying a second voltage less than the sustain voltage. The fourth switch has a first terminal coupled to a third power for supplying a scan voltage sequentially applied to the electrodes in an address period. The second Zener diode has an anode coupled to a second terminal of the fourth switch and a cathode coupled to the electrodes. The fifth switch is coupled between the second power and the third power. The fourth switch operates to control a voltage at the cathode of the second Zener diode to be gradually decreased to a third voltage greater than the scan voltage in part of the reset period in which the second switch is turned off. The fifth switch has a first terminal coupled to an anode of the first Zener diode and a second terminal coupled to a cathode of the first Zener diode.

According to an aspect of the present invention, the driver further includes a sixth switch coupled between the third power and the electrodes, and the sixth switch has a first terminal coupled to the fifth switch. The first voltage is less than the sustain voltage by a breakdown voltage of the first Zener diode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a plasma display device according to an embodiment of the present invention.

FIG. 2 shows a driving waveform of a plasma display device according to an embodiment of the present invention.

FIG. 3 shows a circuit for a scan electrode driver according to an embodiment of the present invention.

FIG. 4 shows a timing diagram of a switch for generating a driving waveform in the reset period in the scan electrode driver of FIG. 3.

FIG. 5 shows a driving operation of a circuit for generating a driving waveform in the reset period according to the timing diagram of FIG. 4.

FIG. 6 shows a circuit of a scan electrode driver according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. To clarify the aspects of the present invention in the drawings, parts that are not related to descriptions are omitted, and the same parts over the specification have the same reference numerals.

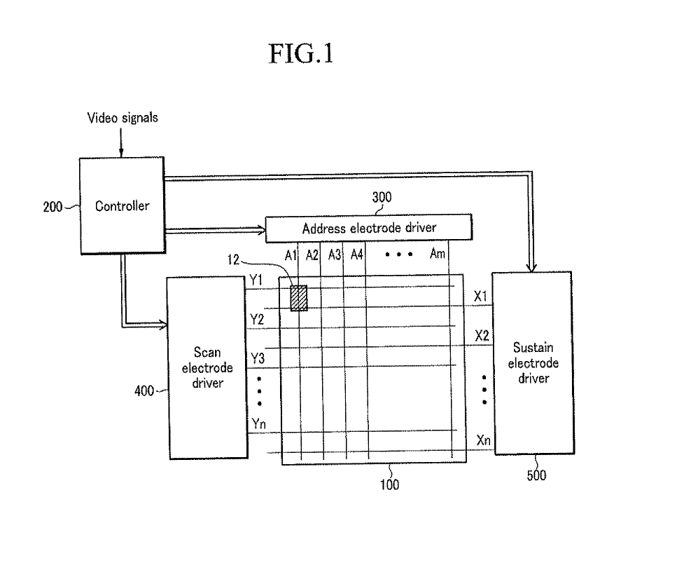

FIG. 1 shows a plasma display device according to an embodiment of the present invention. As shown in FIG. 1, the plasma display device includes a plasma display panel (PDP) 100, a controller 200, an address electrode driver 300, a scan electrode driver 400, and a sustain electrode driver 500. The plasma display panel (PDP) 100 includes a plurality of address electrodes A1-Am (A electrodes) in the column direction, and a plurality of sustain electrodes X1-Xn (X electrodes) and a plurality of scan electrodes Y1-Yn (Y electrodes) in the row direction. The Y electrodes Y1-Yn and the X electrodes X1-Xn are arranged in pairs. A discharge cell 12 is provided at each cross point of the Y electrodes Y1-Yn, the X electrodes X1-Xn, and the A electrodes A1-Am.

The controller 200 receives video signals, and outputs an address electrode drive control signal, a sustain electrode drive control signal, and a scan electrode drive control signal. The controller 200 divides a frame into a plurality of subfields each having a weight.

The address electrode driver 300 receives an address electrode drive control signal from the controller 200 and applies a signal for selecting discharge cells 12 to be displayed to the respective A electrodes A1-Am. The scan electrode driver 400 receives a scan electrode drive control signal from the controller 200 and applies a driving voltage to the Y electrodes Y1-Yn. The sustain electrode driver 500 receives a sustain electrode drive control signal from the controller 200 and applies a driving voltage to the X electrodes X1-Xn.

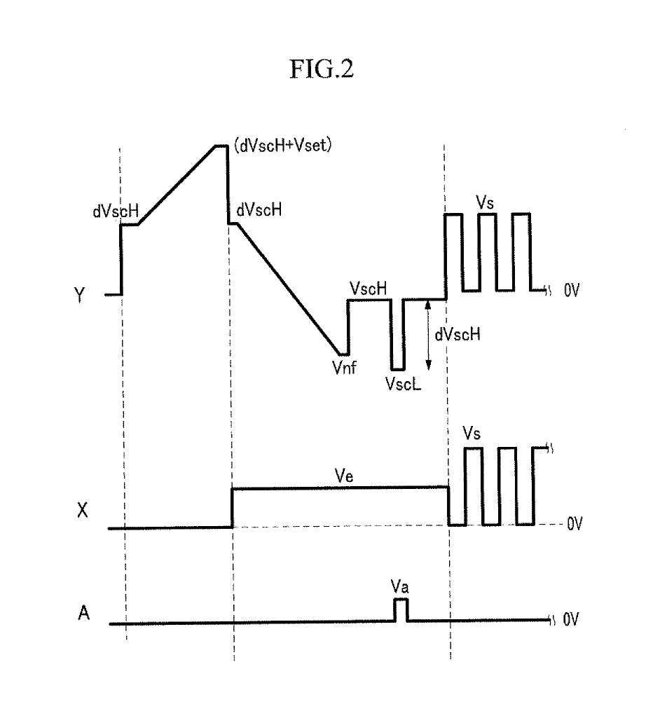

A driving waveform of the plasma display device will now be described with reference to FIG. 2 according to an embodiment of the present invention. For ease of description, a driving waveform applied to the Y electrode, the X electrode, and A the electrode forming a cell will be described.

As shown in FIG. 2, in the rising period of the reset period, a voltage waveform (a reset rising waveform) gradually increasing from the dVscH voltage to the (dVscH+Vset) voltage is applied to the Y electrode while a reference voltage (0V in FIG. 2) is applied to the A electrode and the X electrode. While the reset rising waveform is applied to the Y electrode, a weak discharge is generated between the Y electrode and the X electrode and between the Y electrode and the A electrode. Accordingly, (−) wall charges are formed at the Y electrode and (+) wall charges are formed at the X and A electrodes by the weak discharge generated by the reset rising waveform applied to the Y electrode.

In the falling period of the reset period, a voltage waveform (a reset falling waveform) gradually decreasing from the VscH voltage to the Vnf voltage is applied to the Y electrode while the 0V voltage and the bias voltage (Ve voltage in FIG. 2) are applied to the A electrode and the X electrode respectively. While the reset falling waveform is applied to the Y electrode as described, a weak discharge is generated between the Y electrode and the X electrode and between the Y electrode and the A electrode, and the (−) wall charges formed at the Y electrode and the (+) wall charges formed at the X electrode and A electrode are erased. In general, the (Vnf−Ve) voltage is established to be about the discharge firing voltage (Vfxy) between the Y electrode and the X electrode. In this instance, the discharge firing voltage (Vfxy) indicates a voltage difference between the X electrode and the Y electrode when a discharge is generated between the X electrode and the Y electrode, assuming that the wall voltage between the X electrode and the Y electrode is given as 0V.

The wall voltage between the Y electrode and the X electrode at the finishing point of the falling period almost reaches 0V to thus prevent the cells that are not addressed in the address period from being misfired in the sustain period. Though not illustrated, it is possible to configure the reset falling waveform with a waveform gradually decreasing from the 0V voltage to the Vnf voltage after applying the dVscH voltage and then applying the 0V voltage in order to reduce the time given to the reset period for the purpose of improving the contrast and prevent generation of strong discharge caused by a steep slope of the reset falling waveform.

As shown in FIG. 2, the start voltages of the reset rising waveform and the reset falling waveform are shown to be the dVscH voltage in FIG. 2. It is understood that the dVscH can be set to be a voltage less than the discharge firing voltage between the X electrode and the Y electrode. In this instance, the dVscH voltage is a voltage difference between a scan voltage (VscL in FIG. 2) and a non-scan voltage (VscH in FIG. 2)

In the address period, in order to select the turned on discharge cells, a scan voltage (VscL voltage in FIG. 2) is sequentially applied to a plurality of Y electrodes while the Ve voltage is applied to the X electrode. In this instance, an address voltage (Va voltage in FIG. 2) is applied to the A electrode passed through the discharge cell 12 to be selected from among the discharge cells to which the VscL voltage is applied by the Y electrode. Accordingly, an address discharge is generated between the A electrode to which the Va voltage is applied and the Y electrode to which the VscL voltage is applied and between the Y electrode to which the VscL voltage is applied and the X electrode to which the Ve voltage is applied so that the (+) wall charges are formed at the Y electrode and the (−) wall charges are formed at the A electrode and the X electrode. In this instance, the VscL voltage is set to be equal to or less than the Vnf voltage. A non-scan voltage (VscH voltage in FIG. 2) that is greater than the VscL voltage is applied to at least one Y electrode to which the VscL voltage is not applied, and the 0V voltage is applied to the A electrode of the discharge cell that is not selected.

In the sustain period, a sustain voltage (Vs voltage in FIG. 2) and the 0V voltage in the opposite phase are applied to the Y electrode and the X electrode to generate a sustain discharge between the Y electrode and the X electrode. That is, the process for applying the Vs voltage to the Y electrode and simultaneously the 0V voltage to the X electrode and the process for applying the 0V voltage to the Y electrode and simultaneously the Vs voltage to the X electrode are repeated as many as the number of weights displayed by the corresponding subfield.

In FIG. 2, for ease of description, the reset rising waveform or the reset falling waveform applied to the Y electrode in the reset period is illustrated in the ramp waveform format. However, it is also possible in the embodiment of the present invention to apply gradually rising or falling waveforms such as an RC waveform and a gradually rising (or falling) and floating waveform to the reset rising waveform or reset falling waveform.

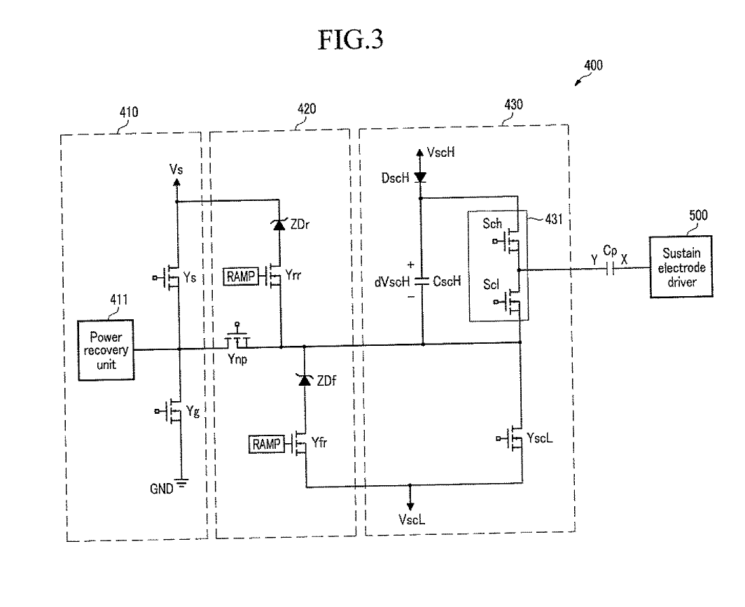

Regarding the scan electrode driver 400 for generating the driving waveform of the Y electrode shown in FIG. 2, an embodiment of the present invention for simplifying the circuit will now be described with reference to FIG. 3. A switch refers to an n-channel field effect transistor (FET) having a body diode (not shown), which is only an example. As such, other elements for performing the same or similar functions as those of the n-channel field effect transistor are applicable to the switch in the shown embodiment. In FIG. 3, a capacitance component formed by the X electrode and the Y electrode is illustrated to be a panel capacitor (Cp).

As shown in FIG. 3, the scan electrode driver 400 includes a sustain driver 410, a reset driver 420, and a scan driver 430. The sustain driver 410 includes a power recovery unit 411, a switch (Ys), and a switch (Yg). The sustain driver 410 alternately applies a Vs voltage and a GND voltage to the Y electrode in the sustain period.

In the sustain driver 410, the power recovery unit 411 includes a power recovery capacitor, a power recovery inductor, a rising path forming switch, and a falling path forming switch. The power recovery capacitor charges a device with the voltage between the Vs voltage and the 0V voltage (e.g., Vs/2 voltage). In this instance, when a switch forming a rising path or a falling path is turned on, an LC resonance current path is formed through a power recovery capacitor, a power recovery inductor, and the panel capacitor (Cp), and the voltage at the panel capacitor (Cp) is increased or decreased. The power recovery unit 411 will not be described in great detail since it is not much related to the embodiment shown in FIG. 1 and is understood by those of ordinary skill in the art.

The switch (Ys) is coupled between the Vs power for supplying the Vs voltage and the Y electrode. The switch (Yg) is coupled between the GND power for supplying the GND voltage and the Y electrode. In the sustain period, the Vs voltage is applied to the Y electrode when the switch (Ys) is turned on, and the GND voltage is applied to the Y electrode when the switch (Yg) is turned on.

The reset driver 420 includes switches (Yrr, Ynp, Yfr) and Zener diodes (ZDr, ZDf). The reset driver 420 applies a reset rising waveform and a reset falling waveform to the Y electrode in the reset period. In the reset driver 420, the switch (Yrr) is coupled between the Vs power and the Y electrode. The Zener diode (ZDr) is coupled between the Vs power and the switch (Yrr). In this instance, the cathode of the Zener diode (ZDr) is coupled to the Vs power, and the anode of the Zener diode (ZDr) is coupled to the first terminal of the switch (Yrr). Therefore, the source voltage of the switch (Yrr) gradually rises to the Vset voltage that is less than the Vs voltage by the breakdown voltage of the Zener diode (ZDr) when the switch (Yrr) is turned on in the rising period of the reset period.

Though not illustrated, and differing from FIG. 3 in which the anode of the Zener diode (ZDr) is coupled to the drain of the switch (Yrr), it is possible in other embodiments to couple the cathode of the Zener diode (ZDr) and the source of the switch (Yrr). In this embodiment, it is necessary to couple the anode of the Zener diode (ZDr) to the Vs power. Hence, the Vset power for supplying the Vset voltage may not be configured by providing the Zener diode (ZDr) between the Vs power and the switch (Yrr).

The switch (Yfr) is coupled between the VscL power for supplying the VscL voltage and the Y electrode. The Zener diode (ZDf) is coupled between the VscL power and the switch (Yfr). That is, the anode of the Zener diode (ZDf) is coupled to the switch (Yfr), and the cathode of the Zener diode (ZDf) is coupled to the Y electrode. In this instance, positions of the Zener diode (ZDf) and the switch (Yfr) can be exchanged. Accordingly, the cathode voltage of the Zener diode (ZDf) gradually falls to the Vnf voltage that is greater than the VscL voltage by the breakdown voltage of the Zener diode (ZDf) when the switch (Yfr) is turned on in the falling period of the reset period.

The switch (Ynp) is coupled between the GND power and the VscL power. The switch (Ynp) is turned off, to prevent the current flow to the GND power, when a voltage less than the 0V voltage is applied to the Y electrode.

The scan driver 430 includes a selection circuit 431, a diode (DscH), a capacitor (CscH), and a switch (YscL). The scan driver 430 sequentially applies the VscL voltage to a plurality of Y electrodes Y1-Yn, and applies the VscH voltage to at least one residual Y electrode to which the VscL voltage is not applied.

The selection circuit 431 includes a switch (Sch) and a switch (Scl). The switch (Sch) is coupled between the VscH power for supplying the VscH voltage and the Y electrode, and the switch (Scl) is coupled between the VscL voltage and the Y electrode. FIG. 3 illustrates the selection circuit 431 coupled to one Y electrode. However, it is understood that a plurality of Y electrodes are coupled to corresponding selection circuits 431, and it is general to configure an integrated circuit IC with a plurality of selection circuits 431.

The anode of the diode (DscH) is coupled to the VscH power. The cathode of the diode (DscH) is coupled to the switch (Sch). The above-configured diode (DscH) prevents generation of a current path flowing in the VscH power direction so that a current path may be formed from the VscH power to the Y electrode when the switch (Sch) is turned on.

The first terminal of the switch (YscL) is coupled to the VscL power, and the second terminal of the switch (YscL) is coupled to the switch (Scl) of the circuit. Also, the capacitor (CscH) is coupled between the switch (Scl) and the switch (Sch). That is, the first terminal of the capacitor (CscH) is coupled to a contact point of the diode (DscH) and the switch (Sch). The second terminal of the capacitor (CscH) is coupled to a contact point of the switch (Scl) and the switch (YscL). Hence, the capacitor (CscH) and the switch (YscL) are coupled in series between the VscH power and the VscL power. The capacitor (CscH) is charged with the dVscH voltage that corresponds to the voltage difference (VscH−VscL) between the VscH and the VscL voltage by a turn-on operation of the switch (YscL) in the initial drive of the plasma display device.

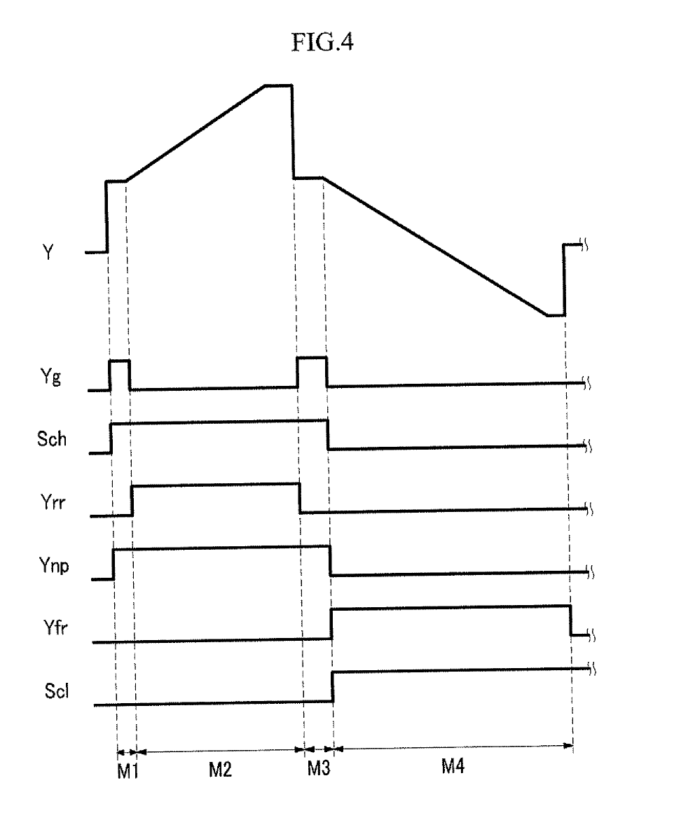

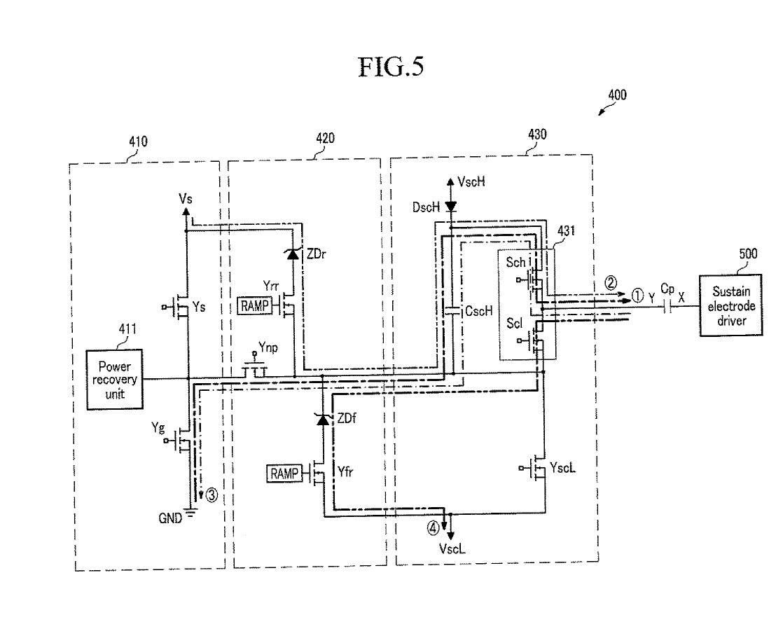

A drive operation by the scan electrode driver 400 of FIG. 3 for generating a driving waveform applied to the Y electrode in the reset period will now be described with reference to FIGS. 4 and 5. FIG. 4 shows a drive timing diagram of the scan electrode driver of FIG. 3 for generating a drive waveform in the reset period from the drive waveform of FIG. 2, and FIG. 5 shows a driving operation of the scan electrode driver 400 of FIG. 3 in the reset period. It is assumed that in the initial drive of the plasma display device the switch (YscL) is turned on to charge the capacitor (CscH) with the dVscH voltage.

As shown in FIG. 4, in the mode 1(M1), the switch (Sch), the switch (Yg), and the switch (Ynp) are turned on. As shown in FIG. 5, the dVscH voltage is applied to the Y electrode through the current path (\textcircled{1}) of the GND power, the switch (Yg), the switch (Ynp), the capacitor (CscH), the switch (Sch), and the panel capacitor (Cp).

In the mode 2 (M2), the switch (Yg) is turned off and the switch (Yrr) is turned on. Accordingly, the reset rising waveform is applied to the Y electrode through the current path (\textcircled{2}) of the Vs power, the Zener diode (ZDr), the switch (Yrr), the switch (Ynp), the capacitor (CscH), the switch (Sch), and the panel capacitor (Cp). In this instance, through the current path (\textcircled{2}), the voltage at the Y electrode gradually increases by the Vset voltage corresponding to the (Vs voltage—breakdown voltage of the Zener diode (ZDr)) from the dVscH to thus apply the (dVscH+Vset) voltage to the Y electrode.

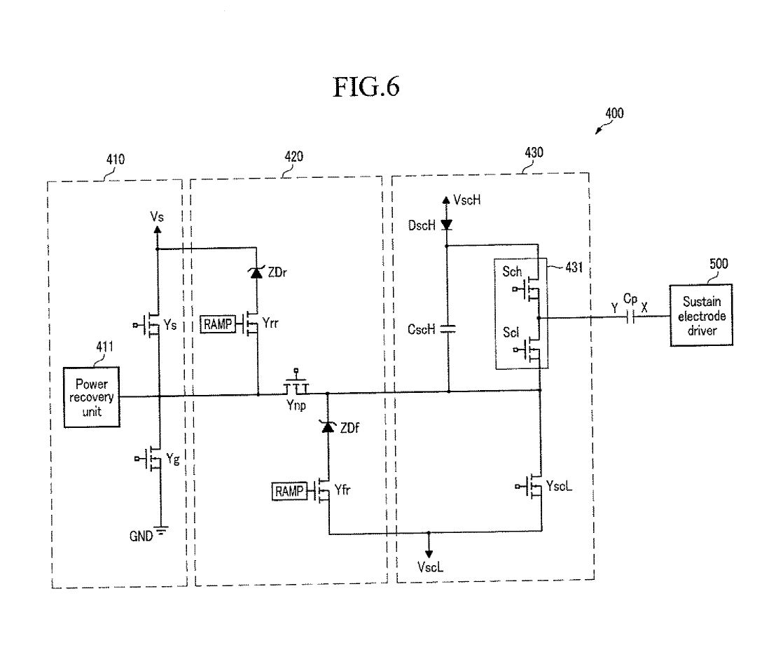

In the mode 3 (M3), the switch (Yrr) is turned off and the switch (Yg) is turned on. As shown in FIG. 6, the dVscH voltage is applied to the Y electrode through the current path (\textcircled{3}) of the panel capacitor (Cp), the switch (Sch), the capacitor (CscH), the switch (Ynp), the switch (Yg), and the GND power.

In the mode 4 (M4), the switch (Sch), the switch (Yg), and the switch (Ynp) are turned off, and the switch (Yfr) and the switch (Scl) are turned on. Accordingly, the reset failing waveform is applied to the Y electrode through the current path (\textcircled{4}) of the panel capacitor (Cp), the switch (Scl), the Zener diode (ZDf), the switch (Yfr), and the VscL power. By the current path (\textcircled{4}), the voltage at the Y electrode gradually decrease from the dVscH voltage to the Vnf voltage. In this instance, the Vnf voltage is greater than the negative voltage. (that is, the VscL voltage by the breakdown voltage of the Zener diode (ZDf).

In the reset falling waveform gradually falling from 0V to the Vnf voltage after the dVscH is applied, a mode 5 (M5) can be added between the mode 3 (M3) and the mode 4 (M4). In the mode 5 (M5), the switch (Sch) is turned off and the switch (Scl) is turned on. Hence, 0V is applied to the Y electrode through a current path of the panel capacitor (Cp), the switch (Scl), the switch (Ynp), the switch (Yg), and the GND power. In the mode 4 (M4), the switch (Yg) is turned off and the switch (Yfr) is turned on to apply the reset falling waveform to the Y electrode through the current path (\textcircled{4}).

According to the shown embodiment, the Vset voltage can be generated by the sustain voltage supplied by the Vs power and the breakdown voltage of the Zener diode (ZDr) coupled to the Vs power. As a result, the number of power sources required for the circuit 400 can be reduced since there is no need to configure the power for supplying the Vset voltage. Also, as checked from the driving waveform of FIG. 2, no additional element for preventing the Vset voltage from being overcharged may be needed while applying the Vs voltage to the Y electrode in the sustain period when the Vset voltage is set to be less than the Vs voltage. Therefore, the scan electrode driver circuit 400 is simplified and the plasma display device cost is reduced.

According to the shown embodiment, the current flow to the GND power is prevented by a turn off operation on the switch (Ynp) when the switch (Yfr) or the switch (YscL) is turned on to apply a negative voltage less than the GND voltage to the Y electrode. In the scan electrode driver shown in FIG. 3, it was necessary to use the switch (Yrr) and the Zener diode (ZDr) each with a great withstand voltage since the withstand voltage of (Vs voltage+VscL voltage) can be applied to the switch (Yrr) and the Zener diode (ZDr) to the maximum while applying the Vnf voltage or VscL voltage less than the 0V voltage to the Y electrode.

Hereinafter, a plasma display device and a driving apparatus thereof for reducing the withstand voltage applied to the switch (Yrr) and the Zener diode (ZDr) will now be described with reference to the scan electrode driver 400 according to an embodiment of the present invention shown in FIG. 6. As shown in FIG. 6, the scan electrode driver 400 corresponds to the scan electrode driver 400 of the embodiment shown in FIG. 3. However, the switch (Ynp) is coupled between the switch (Yrr) and the VscL power, and hence, no descriptions corresponding to the first embodiment will be provided.

According to the embodiment shown in FIG. 6, the switch (Ynp) is coupled between the switch (Yrr) and the VscL power. That is, the first terminal of the switch (Ynp) is coupled to the switch (Yrr), and the second terminal of the switch (Ynp) is coupled to a contact point of the switch (YscL) and the Zener diode (ZDf). Accordingly, when the switch (Yfr) or the switch (YscL) is turned on, the withstand voltage of the Vs voltage is applied to the switch (Yrr) and the Zener diode (ZDr) to the maximum.

That is, compared to the embodiment shown in FIG. 6, the withstand voltage applied to the switch (Yrr) and the Zener diode (ZDr) is reduced when the voltage less than the 0V voltage is applied to the Y electrode. Therefore, the reliability of circuit 400 is improved since the withstand voltage applied to the elements is reduced, and the plasma display device production cost is reduced since the elements having a great withstand voltage may not be used.

While aspects of this invention have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an aspect of the present invention, the number of power sources is reduced to thus simplify the circuit configuration. Also, circuit stability can be improved by reducing the withstand voltage applied to the lamp switch.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel (PDP) including a plurality of electrodes; and
an electrode driver for applying a drive voltage to the electrodes to form an image, wherein
the electrode driver comprises:
a first switch coupled between the electrodes and a first power for generating a sustain voltage, the first switch applying the sustain voltage to the electrodes in a sustain period;
a first diode having a cathode coupled to the first power; and
a second switch having a first terminal coupled to an anode of the first diode, and operating to control a voltage at a second terminal to be gradually increased to a first voltage less than the sustain voltage in part of a reset period.

2. The plasma display device of claim 1, wherein the electrode driver further comprises:
a third switch coupled between the electrodes and a second power for supplying a second voltage less than the sustain voltage;
a fourth switch coupled between the electrodes and a third power for supplying a scan voltage sequentially applied to the electrodes in an address period; and
a fifth switch, coupled between the second power and the third power, for preventing a voltage less than the second voltage from being applied to the second power when the voltage less than the second voltage is applied to the electrodes.

3. The plasma display device of claim 2, wherein the fifth switch has a first terminal coupled to a second terminal of the second switch.

4. The plasma display device of claim 2, wherein the electrode driver further comprises:
a second diode having a cathode coupled to the electrodes; and
a sixth switch having a first terminal coupled to an anode of the second diode and a second terminal coupled to the third power, and operating to control the voltage at an anode of the second diode to be gradually decreased to a third voltage greater than the scan voltage in part of the reset period in which the second switch is turned off.

5. The plasma display device of claim 4, wherein the electrode driver further comprises a capacitor having a first terminal coupled to a fourth power for supplying a fourth voltage greater than the scan voltage, and the capacitor is charged with a fifth voltage corresponding to a voltage difference between the fourth voltage and the scan voltage through a turn on operation of the fourth switch.

6. The plasma display device of claim 5, wherein when the second switch is turned on, the voltage at the electrodes is gradually increased from the fifth voltage to a sixth voltage that is the sum of the fourth voltage and the fifth voltage through a current path including the first power, the first diode, the second switch, the fifth switch, and the capacitor.

7. The plasma display device of claim 1, wherein the first voltage is less than the sustain voltage caused by a breakdown voltage of the first diode.

8. A driver for a plasma display device including a plurality of electrodes, the driver comprising:
a first switch, coupled between the electrodes and a first power for generating a sustain voltage, the first switch applying the sustain voltage to the electrodes when the first switch is turned on;
a second switch having a first terminal coupled to the first power; and
a first Zener diode having a cathode coupled to a second terminal of the second switch and an anode coupled to the electrodes, wherein
the second switch operates to control a voltage at the anode of the first Zener diode to be gradually increased to a first voltage less than the sustain voltage in part of the reset period.

9. The driver of claim 8, further comprising:
a third switch coupled between the electrodes and a second power for supplying a second voltage less than the sustain voltage;
a fourth switch having a first terminal coupled to a third power for generating a scan voltage, the fourth switch sequentially applying the scan voltage to the electrodes in an address period;
a second Zener diode having an anode coupled to a second terminal of the fourth switch and a cathode coupled to the electrodes; and
a fifth switch coupled between the second power and the third power, wherein the fourth switch operates to control a voltage at the cathode of the second Zener diode to be gradually decreased to a third voltage greater than the scan voltage in part of the reset period in which the second switch is turned off.

10. The driver of claim 9, wherein
the fifth switch has a first terminal coupled to the anode of the first Zener diode and a second terminal coupled to the cathode of the first Zener diode.

11. The driver of claim 9, further comprising
a sixth switch coupled between the third power and the electrodes,
the sixth switch having a first terminal coupled to the fifth switch.

12. The driver of claim 8, wherein
the first voltage is less than the sustain voltage caused by a breakdown voltage of the first Zener diode.

13. A scan electrode driver for a plasma display device comprising:
a sustain driver including first and second switches, the sustain driver selectively activating the first and second switches to alternately apply a first voltage and a second voltage to a plurality of electrodes of the plasma display device in a sustain period; and
a reset driver including third, fourth and fifth switches and first and second diodes, the reset driver selectively activating the third, fourth and fifth switches to supply voltage to the first and second diodes to apply a reset rising waveform and a reset failing waveform to the plurality of electrodes in a reset period.

14. The driver of claim 13, wherein
the first switch is coupled between a first power supply supplying the first voltage and the plurality of electrodes,
the second switch is coupled between a second power supply supplying the second voltage and the plurality of electrodes, and
wherein in the sustain period, the first voltage is applied to the electrodes when the first switch is turned on, and the second voltage is applied to the plurality of electrodes when the second switch is turned on.

15. The driver of claim 13, wherein
in the reset driver, the third switch is coupled between the first diode and the plurality of electrodes, and the first diode is coupled between a first power supply supplying the first voltage and the third switch, and
a source voltage of the third switch gradually rises to a set voltage that is less than the first voltage due to a breakdown voltage of the first diode when the third switch is turned on in a rising period of the reset period.

16. The driver of claim 13, further comprising a scan driver including a selection circuit, a third diode, a first capacitor, and a sixth switch, wherein the scan driver sequentially applies a third voltage to the plurality of electrodes, and applies a fourth voltage to at least one residual electrode of the plurality of electrodes to which the fourth voltage is not applied.

17. The driver of claim 16, wherein the selection circuit includes seventh and eight switches, the seventh switch coupled between a fifth power supply generating a fifth voltage and the plurality of electrodes and the sixth switch coupled between a fourth power supply generating the fourth voltage and the plurality of electrodes.

18. The driver of claim 17, wherein an anode of the third diode is coupled to the fifth power supply and a cathode of the third diode is coupled to the seventh switch, preventing a generation of a current path flowing in the fifth power supply direction so that a current path is not formed from the fifth power supply to the plurality of electrodes when the seventh switch is turned on.

19. The driver of claim 13, wherein the first voltage is a sustain voltage and the second voltage is a ground voltage.

20. A method of driving a scan electrode driver for a plasma display device, the method comprising:
selectively activating first and second switches of a sustain driver, to alternately apply a first voltage and a second voltage to a plurality of electrodes of the plasma display device in a sustain period; and
selectively activating third, fourth and fifth switches to supply voltage to first and second diodes of a reset driver to apply a reset rising waveform and a reset failing waveform to the plurality of electrodes in a reset period.

21. A plasma display device comprising:
a plasma display panel (PDP) including a plurality of electrodes; and
an electrode driver for applying a drive voltage to the electrodes to form an image, wherein
the electrode driver comprises:
a first switch coupled between electrodes and a first power for generating a sustain voltage, the first switch applying the sustain voltage to the electrodes in a sustain period; and
a second switch having a first terminal coupled between the first power and a first diode, the second switch operating to control a voltage at a second terminal to be gradually increased to a first voltage less than the sustain voltage in part of a reset period.
